(19) United States
(12) Patent Application Publication
(10) Pub. No.: US 2026/0019515 A1
(43) Pub. Date: Jan. 15, 2026

(54) MEDIUM DETECTION DEVICE AND ELECTRONIC APPARATUS

(71) Applicant: SEIKO EPSON CORPORATION, TOKYO (JP)

(72) Inventor: Hiroki KOYAMA, ASAHI-MURA (JP)

(21) Appl. No.: 19/266,213

(22) Filed: Jul. 11, 2025

(30) Foreign Application Priority Data
Jul. 11, 2024 (JP) 2024-111820

(51) Int. Cl. H04N 1/00

(52) U.S. Cl. CPC H04N 1/00689; H04N 1/00734

(57) ABSTRACT

A medium detection device includes a lever disposed in a transport path and being movable in contact with a medium transported in a transport direction along the transport path, and a sensor detecting the medium based on movement of the lever. The lever includes an end portion contact portion having an elongated sliding surface with which an end portion in the transport direction of the medium transported along the transport path comes into contact and slides, and a wide surface portion provided in the end portion contact portion and having a wide surface with a width dimension larger than a width dimension of the end portion contact portion in a width direction intersecting the transport direction, and the sliding surface projects from the wide surface to be antecedently in contact with the end portion of the transported medium.

The present application is based on, and claims priority from JP Application Serial Number 2024-111820, filed Jul. 11, 2024, the disclosure of which is hereby incorporated by reference herein in its entirety.

### BACKGROUND

### 1. Technical Field

The present disclosure relates to a medium detection device and an electronic apparatus.

### 2. Related Art

An example of related art of this type of apparatus is disclosed in JP-A-2014-166892.

JP-A-2014-166892 discloses that a medium detection mechanism includes a detection lever pressed and moved in contact with an end portion of a transported medium and a detector detecting the presence or absence of the medium according to displacement due to the movement of the detection lever.

JP-A-2014-166892 is an example of the related art.

In JP-A-2014-166892, the detection lever has a narrow width shape in order to accurately detect the position or the like of the transported medium. When the detection lever has the narrow width shape, a range in which the end portion of the medium comes into contact with the detection lever is concentrated in a narrow range of the narrow width shape. That is, the reaction force received by the end portion of the medium from the detection lever is concentrated in the narrow range of the narrow width shape. Therefore, when a medium having low rigidity, in other words, a medium having low stiffness is transported, an end portion of the medium and a surface portion coupled to the end portion may be deformed by the reaction force.

Alternatively, when a medium with a hole formed therein such as a loose leaf is transported, first, an end portion of the medium comes into contact with the detection lever and the detection lever is displaced, so that the medium is detected. Thereafter, when the medium is further transported, a tip portion of the detection lever is in a contact state following the surface of the medium. In this case, the tip portion may fall into the hole of the medium because the detection lever has the narrow width shape. When the detection lever falls into the hole of the medium, the detection lever returns to the original position and is detached from the detector. As a result, the position and size of the medium may be falsely detected.

Accordingly, a configuration is conceivable in which the width dimension of the detection lever is made larger than the diameter dimension of the hole of the medium to prevent from falling into the hole of the medium. However, when the width dimension of the detection lever is simply increased, the contact point with the end portion of the medium becomes unstable, and the detection accuracy of the position or the like of the medium decreases.

### SUMMARY

To solve the problem described above, a medium detection device according to an aspect of the present disclosure includes a lever disposed in a transport path and being movable in contact with a medium transported in a transport direction along the transport path, and a sensor detecting the medium based on movement of the lever, wherein the lever includes an end portion contact portion having an elongated sliding surface with which an end portion in the transport direction of the medium transported along the transport path comes into contact and slides, and a wide surface portion provided in the end portion contact portion and having a wide surface with a width dimension larger than a width dimension of the end portion contact portion in a width direction intersecting the transport direction, and the sliding surface projects from the wide surface to be antecedently in contact with the end portion of the transported medium.

An electronic apparatus according to an aspect of the present disclosure includes the medium detection device according to any one of the first to eighth configurations described below, a medium transport unit that transports the medium along the transport path, and a processing unit that executes processing on the transported medium.

### BRIEF DESCRIPTION OF THE DRAWINGS

FIG. 1 is a side sectional view of a main part corresponding to a medium detection device and an image reading apparatus according to Embodiment 1.

FIG. 2 is an enlarged side sectional view of the main part in FIG. 1 and a partially enlarged view.

FIG. 3 is a perspective view of the medium detection device of Embodiment 1.

FIG. 4 is a perspective view of a medium detection device of Embodiment 2.

FIG. 5 is a perspective view of a medium detection device of Embodiment 3.

FIG. 6 shows a method of determining an amount of projection of a sliding surface from a wide surface.

FIG. 7 shows the method of determining the amount of projection of the sliding surface from the wide surface.

### DESCRIPTION OF EMBODIMENTS

First, the present disclosure will be schematically described.

To solve the problem described above, a medium detection device according to a first configuration of the present disclosure includes a lever disposed in a transport path and being movable in contact with a medium transported in a transport direction along the transport path, and a sensor detecting the medium based on movement of the lever, wherein the lever includes an end portion contact portion having an elongated sliding surface with which an end portion in the transport direction of the medium transported along the transport path comes into contact and slides, and a wide surface portion provided in the end portion contact portion and having a wide surface with a width dimension larger than a width dimension of the end portion contact portion in a width direction intersecting the transport direction, and the sliding surface projects from the wide surface to be antecedently in contact with the end portion of the transported medium.

According to the configuration, the lever includes the end portion contact portion having the elongated sliding surface with which the end portion in the transport direction of the medium transported along the transport path comes into contact and slides, and the wide surface portion provided in the end portion contact portion and having the wide surface with the width dimension larger than the width dimension of the end portion contact portion in the width direction intersecting the transport direction. Further, in the lever, the sliding surface projects from the wide surface to be antecedently in contact with the end portion of the transported medium.

(1) Accordingly, the end portion of the transported medium antecedently comes into contact with the sliding surface of the end portion contact portion having a narrow width projecting from the wide surface. Since the sliding surface is elongated, when the end portion of the medium contacts the sliding surface and the lever starts to move, the portion of the end portion of the medium in contact with the sliding surface slides and advances in the transport direction while maintaining a contact state with the sliding surface. As the medium advances in the transport direction, the contact position with the sliding surface gradually and continuously moves from the end portion to the surface side. Accordingly, the medium starts to bend in a concave shape with the contact portion with the sliding surface as a base point. That is, in the medium, the other surface portion in the width direction coupled to the portion in contact with the sliding surface of the leading end surface portion in the transport direction of the medium starts to approach the wide surface.

The degree of approach of the surface portion of the medium approaching the wide surface to the wide surface varies depending on the rigidity of the medium. A medium having high rigidity is often transported in a state where the surface portion is in contact with only the sliding surface and is not in contact with the wide surface. On the other hand, a medium having low rigidity is often transported in a state where the surface portion is in contact with the sliding surface and is also in contact with the wide surface.

That is, in the medium having low rigidity, the reaction force of the lever is received by both the portion of the medium in contact with the sliding surface and a portion of the medium in contact with the wide surface. Accordingly, the concentration of the reaction force received from the lever on the sliding surface having the narrow width as in the related art can be suppressed, and thus the possibility that the end portion of the medium and the surface portion coupled to the end portion are deformed by the reaction force can be reduced. Further, the width of the sliding surface with which the end portion of the medium comes into contact can be narrowed, and the lever can accurately detect the position or the like of the transported medium.

The amount of projection of the sliding surface from the wide surface is set based on the type of the medium assumed to be transported and the degree of each rigidity.

(2) When the medium is formed with holes like a loose leaf, as described above, the contact position of the medium with the sliding surface gradually and continuously moves from the end portion to the surface side as the medium advances in the transport direction. In this regard, in a case where the position of the end portion contact portion and the hole are located in a line in the transport direction, when the leading end portion of the medium passes the contact position with the sliding surface, a distal end part of the end portion contact portion is likely to fall into the hole. However, in the configuration, the wide surface portion can reduce the possibility of falling into the hole. Here, the width dimension of the wide surface portion is preferably set to be larger than the size of the hole.

A medium detection device according to a second configuration of the present disclosure is the configuration according to the first configuration, in which the lever is pivotable with a shaft portion as a pivot fulcrum and with the end portion contact portion and the wide surface portion as a free end, and when the end portion contact portion completely pivots in contact with the medium being transported, a distal end part of the wide surface portion comes into contact with a surface of the medium.

According to the configuration, the lever is pivotable with the shaft portion as the pivot fulcrum and with the end portion contact portion and the wide surface portion as the free end. Further, in the lever, when the end portion contact portion completely pivots in contact with the medium being transported, the distal end part of the wide surface portion comes into contact with the surface of the medium. Here, in the lever, “when the end portion contact portion completely pivots” refers to a state in which the end portion of the medium passes through the position of the sliding surface while sliding along the sliding surface of the end portion contact portion and the lever reaches the upper limit of the pivot.

That is, when the end portion of the medium passes through the position of the sliding surface and the lever completely pivots, the distal end part of the wide surface portion comes into contact with the surface of the medium, thereby stabilizing the subsequent transport state of the medium as compared with a state where the medium is transported in contact with only the end portion contact portion.

A medium detection device according to a third configuration of the present disclosure is the configuration according to the second configuration, the sliding surface is inclined with respect to the wide surface, and the amount of projection of the sliding surface from the wide surface is larger at a side closer to the shaft portion and smaller at a side farther from the shaft portion.

According to the configuration, the sliding surface is inclined with respect to the wide surface, and the amount of projection of the sliding surface from the wide surface is larger at the side closer to the shaft portion and smaller at the side farther from the shaft portion. Accordingly, the effect of the first configuration can be obtained more effectively as compared with a structure in which the sliding surface is not inclined with respect to the wide surface.

A medium detection device according to a fourth configuration of the present disclosure is the configuration according to the first configuration, the width dimension of the wide surface is larger than 8.5 mm.

Note that the configuration can be made to depend on the second configuration or the third configuration.

According to the configuration, the width dimension of the wide surface is larger than 8.5 mm. As a result, the possibility of falling into the hole of the normal loose leaf can be reduced.

A medium detection device according to a fifth configuration of the present disclosure is the configuration according to the first configuration, in which the lever is movable in a forward direction and a reverse direction of the transport direction, and the end portion contact portion and the wide surface portion are respectively provided on both of a surface facing the forward direction and a surface facing the reverse direction.

Note that the configuration can be made to depend on any one of the second configuration to the fourth configuration.

According to the configuration, the lever is movable in the forward direction and the reverse direction of the transport direction, and the end portion contact portion and the wide surface portion are respectively provided on both of the surface facing the forward direction and the surface facing the reverse direction. Accordingly, even when the medium is transported in the forward direction or in the reverse direction with respect to the end portion contact portion, the effect of the first configuration can be obtained for the transport in both directions.

A medium detection device according to a sixth configuration of the present disclosure is the configuration according to the first configuration, in which the end portion contact portion is disposed at a center part in the width direction intersecting the transport direction of the transport path along which the medium is transported.

Note that the configuration can be made to depend on any one of the second configuration to the fifth configuration.

According to the configuration, the end portion contact portion is configured to be disposed at the center part in the width direction intersecting the transport direction of the transport path along which the medium is transported. That is, since a substantially center part in the width dimension of the medium comes into contact with the end portion contact portion, the detection accuracy of the presence or absence of the medium can be improved.

A medium detection device according to a seventh configuration of the present disclosure is the configuration according to the second configuration, in which the width dimension of the wide surface portion is gradually smaller from the distal end part toward a proximal end part. That is, the wide surface portion has a substantially triangular shape in a plan view.

Note that the configuration can be made to depend on any one of the third configuration to the sixth configuration.

According to the configuration, the width dimension of the wide surface portion is configured to be gradually smaller from the distal end part toward the proximal end part. Accordingly, an increase in weight due to the provision of the wide surface portion can be suppressed as compared with a case of a substantially quadrangular shape.

A medium detection device according to an eighth configuration of the present disclosure is the configuration according to the second configuration, in which the wide surface portion is present in a range from a position where the transported medium first comes into contact over the distal end part in a region where the end portion contact portion extends.

Note that the configuration can be made to depend on any one of the third configuration to the sixth configuration.

Here, “the position where the medium first comes into contact” at “the position where the transported medium first comes into contact in the region where the end portion contact portion extends” is not required to be a position that is strictly determined as one point in this specification, but is used in a sense of a position having a certain range in consideration of displacement of the leading end position of the transported medium or the like.

According to the configuration, the wide surface portion is configured to be present in the range from the position where the transported medium first comes into contact over the distal end part in the region where the end portion contact portion extends. Accordingly, an increase in weight due to the provision of the wide surface portion can be suppressed.

An electronic apparatus according to a ninth configuration of the present disclosure includes the medium detection device according to any one of the first to eighth configurations, a medium transport unit that transports the medium along the transport path, and a processing unit that executes processing on the transported medium.

According to the configuration, in an electronic apparatus such as a recording apparatus or an image reading apparatus, the same effects as those of any one of the first to eighth configurations can be obtained.

### Embodiments

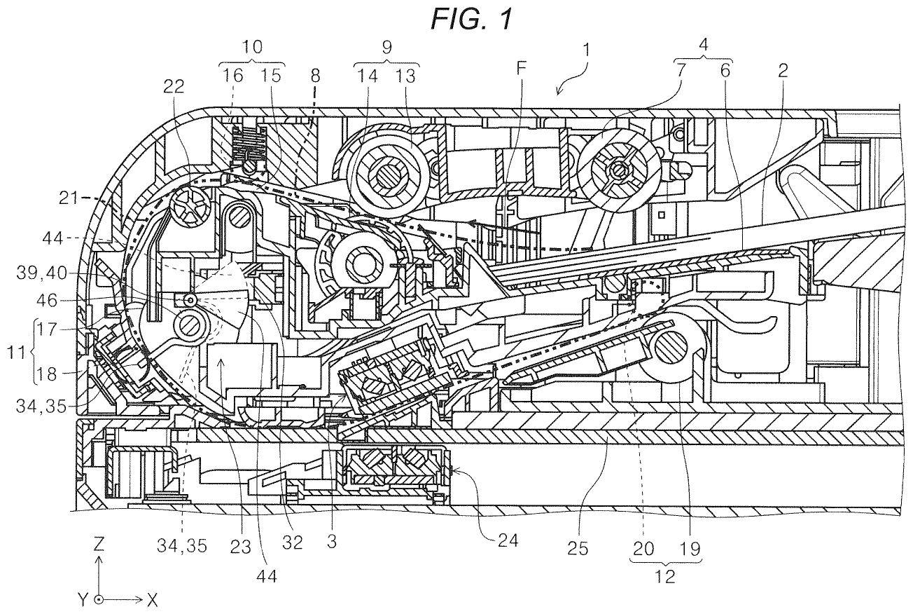

A medium detection device according to an embodiment of the present disclosure and an image reading apparatus including the medium detection device will be specifically described with reference to FIGS. 1 to 7.

In the following description, three axes orthogonal to one another are respectively defined as an X axis, a Y axis, and a Z axis as shown in the respective drawings. The directions indicated by arrows of the three axes (X, Y, Z) are + directions of the respective directions, and the opposite directions are − directions. The Z-axis directions correspond to vertical directions, that is, directions in which the gravity acts, the +Z direction indicates the vertically upward direction and the −Z direction indicates the vertically downward direction. The X-axis directions and the Y-axis directions correspond to horizontal directions. The +Y direction indicates the frontward direction of the apparatus, and the −Y direction indicates the rearward direction of the apparatus. The +X direction indicates the rightward direction of the apparatus, and the −X direction indicates the leftward direction of the apparatus.

### Schematic Overall Description of Electronic Apparatus and Medium Detection Device

An electronic apparatus of the embodiment is an image reading apparatus that can read an image on a medium, that is, a scanner. Here, the image refers to an image visually recorded on the medium, for example, a character, a figure, a table, a picture, or a photograph. The medium is not limited to a sheet, but includes a card, a booklet, and the like.

As illustrated in FIG. 1, an image reading apparatus 1 of the embodiment includes a first reading unit 3 that can read an image on a medium 2, a medium feeding unit 4, and a medium transport unit.

The first reading unit 3 includes an image reading sensor (CIS: Contact Image Sensor) as a processing unit for image reading processing, and has a shape elongated in the Y-axis directions. The image on the transported medium 2 is read when passing through the reading position of the CIS.

The medium feeding unit 4 includes a medium mounting portion 6 and a feeding roller 7. The medium 2 mounted on the medium mounting portion 6 is fed in a transport direction F by the feeding roller 7.

The feeding roller 7 is configured to be movable toward and away from the medium 2 mounted on the medium mounting portion 6. The feeding roller 7 moves to a position in contact with the medium 2, and feeds the medium 2 by rotating with power transmitted from a drive source (not illustrated).

The medium transport unit includes a feed roller pair 9, a first transport roller pair 10, a second transport roller pair 11, and a third transport roller pair 12 disposed along a transport path 8 along which the medium 2 is transported. In FIG. 1, the transport path 8 is indicated by a two-dot chain line.

The feed roller pair 9 includes a feed roller 13 and a separation roller 14. The feed roller 13 rotates by power transmitted from a drive source (not illustrated) and applies a feeding force in the transport direction F to the medium 2. When the medium 2 is multi-fed, the separation roller 14 nips the medium 2 with the feed roller 13 and separates only one sheet of the medium 2 in contact with the feed roller 13 so as to be fed in the transport direction F.

The first transport roller pair 10 includes a driving roller 15 and a driven roller 16. The second transport roller pair 11 includes a driving roller 17 and a driven roller 18. The third transport roller pair 12 includes a driving roller 19 and a driven roller 20. All of the driving roller 15, the driving roller 17, and the driving roller 19 rotate by power transmitted from drive sources (not illustrated), and apply feeding forces in the transport direction F to the medium 2.

In the embodiment, as illustrated in FIG. 1, the transport path 8 has a curved path 21 that is inverted in a substantially U shape downstream the first transport roller pair 10. A sign 22 denotes a driven roller disposed in the curved path 21. The first reading unit 3 is disposed in a region downstream the curved path 21 of the transport path 8 and upstream the third transport roller pair 12. Further, in the embodiment, the first reading unit 3 is disposed below the feed roller pair 9, that is, is disposed to overlap each other in the Z directions. The third transport roller pair 12 is disposed below the medium mounting portion 6. Further, the third transport roller pair 12 is disposed below the feeding roller 7, that is, is disposed to overlap each other in the Z directions.

The second transport roller pair 11 is located in a region of the curved path 21. A medium detection device 23 is disposed near the second transport roller pair 11. The medium detection device 23 detects the position of the medium 2 being transported on the transport path 8. The medium detection device 23 will be described in detail later.

The image reading apparatus 1 of the embodiment includes a second reading unit 24. The second reading unit 24 reads an image on the medium 2 placed on a transparent glass table 25 in a stationary state. The second reading unit 24 is configured to read the image while moving along the surface of the medium 2 in the stationary state.

The glass table 25 is configured such that the entire of parts of the first reading unit 3, the medium feeding unit 4, the medium transport unit, and the like located above the glass table 25 can pivot to be exposed. The glass table 25 is exposed and the medium 2 can be mounted thereon.

### Embodiment 1

### Medium Detection Device

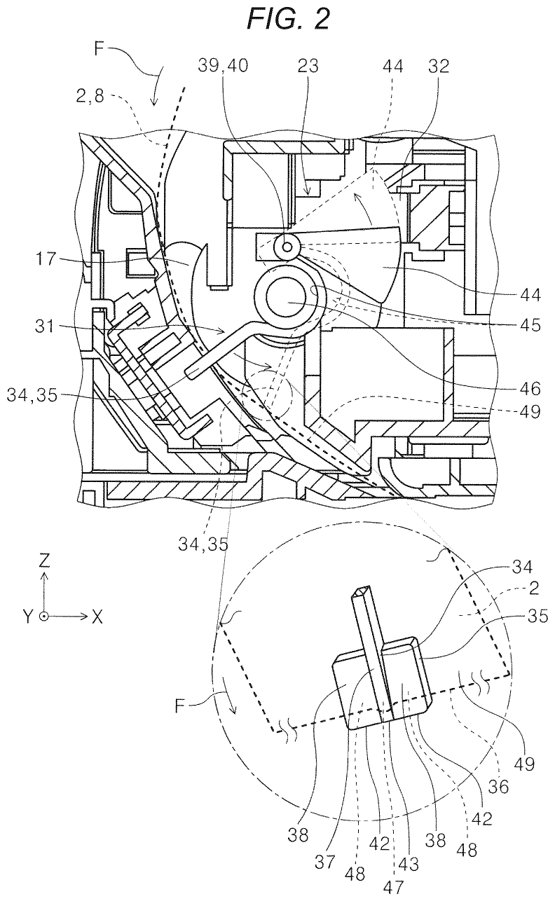

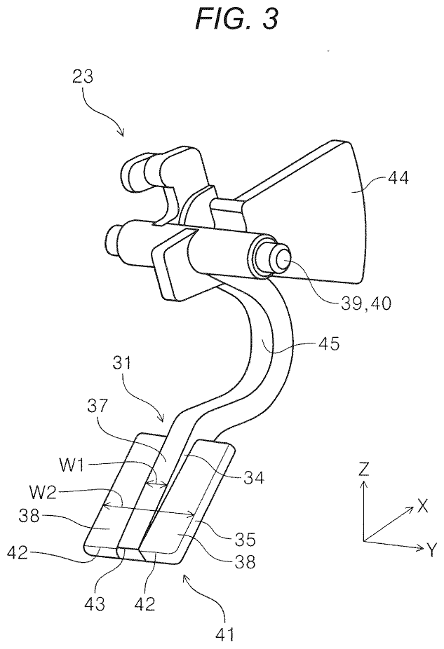

A medium detection device 23 of Embodiment 1 will be described below with reference to FIGS. 2 and 3.

As described above, the medium detection device 23 of Embodiment 1 is disposed in the curved path 21 of the transport path 8. The medium detection device 23 includes a lever 31 movable in contact with the medium 2 transported in the transport direction F along the transport path 8, and a sensor 32 that detects the passage of the medium 2 based on the movement of the lever 31.

Here, the movement of the lever 31 is movement by pivot in the embodiment. The pivoting structure of the lever 31 will be described later.

As shown in FIG. 3, the lever 31 includes an end portion contact portion 34 and a wide surface portion 35. The end portion contact portion 34 has an elongated sliding surface 37 with which an end portion 36 in the transport direction F of the medium 2 transported along the transport path 8 comes into contact and slides. The wide surface portion 35 is provided in the end portion contact portion 34. The wide surface portion 35 has wide surfaces 38 having a width dimension W2 larger than a width dimension W1 of the end portion contact portion 34 in the Y-axis directions as width directions intersecting the transport direction F. Here, the sliding surface 37 is disposed at the center in the width directions of the wide surfaces 38.

The sliding surface 37 projects from the wide surfaces 38 toward the upstream side in the transport direction F to be antecedently in contact with the end portion 36 of the transported medium 2. The amount of projection of the sliding surface 37 from the wide surfaces 38 is set based on the type of the medium 2 assumed to be transported, the degree of each rigidity, and further, the limit of the skew of the transported medium, and the like.

That is, as illustrated in FIG. 3, the portion of the lever 31 with which the transported medium 2 comes into contact has a structure in which the end portion contact portion 34 having the narrow sliding surface 37 projects from the wide surfaces 38 of the wide surface portion 35. In the embodiment, the lever 31 is formed by integral molding of a synthetic resin.

As illustrated in FIGS. 2 and 3, in the embodiment, a free end 41 of the lever 31 is rotatable with a shaft portion 39 as a pivot fulcrum 40. The shaft portion 39 is attached to a structural member such as a frame of the image reading apparatus 1 so as to be rotatable about an axis. The free end 41 includes the end portion contact portion 34 and the wide surface portion 35. That is, the end portion contact portion 34 pivots with the shaft portion 39 as the pivot fulcrum 40 in contact with the medium 2 being transported.

In a state in which the lever 31 pivots and the end portion contact portion 34 completely pivots, distal end parts 42 of the wide surface portion 35, that is, the distal end parts 42 of the wide surfaces 38 come into contact with a surface 49 of the medium 2. Here, in the lever 31, the state in which the end portion contact portion 34 completely pivots refers to a state in which the end portion 36 of the medium 2 passes through the position of the sliding surface 37 while sliding along the sliding surface 37 of the end portion contact portion 34 and the lever 31 reaches the upper limit of the pivot.

As illustrated in FIG. 2, the lever 31 is provided such that the end portion contact portion 34 and the wide surface portion 35 enter the transport path 8 in a state in which the medium 2 is not transported. The shaft portion 39 is provided with a torsion coil spring (not shown). The torsion coil spring applies a spring force so as to pivot the lever 31 clockwise in FIG. 2. The lever 31 is provided with a concave restricted portion 45. When the lever 31 pivots clockwise by the spring force, the restricted portion 45 comes into contact with a restricting portion 46 to stop the pivot, and the lever enters the transport path 8 indicated by the solid line in FIG. 2.

When the transported medium 2 contacts the lever 31, the lever pivots counterclockwise against the spring force into a state indicated by a broken line in FIG. 2, that is, a state in which the end portion contact portion 34 completely pivots. After one sheet of the medium 2 passes and the contact with the medium 2 is lost, the lever 31 returns to the state of entry into the transport path 8 indicated by the solid line in FIG. 2 by the spring force. The restricting portion 46 is provided using a shaft of the driving roller 17.

The lever 31 includes a fan-shaped light blocking portion 44 at the shaft portion 39. The light blocking portion 44 pivots integrally with the shaft portion 39 when the lever 31 pivots. The sensor 32 is an optical sensor having a light emitting portion and a light receiving portion (not shown).

When the lever 31 is located at the position indicated by the solid line in FIG. 2, the light blocking portion 44 is located at a position where the light blocking portion does not block the light beam emitted from the light emitting portion of the sensor 32, and the sensor 32 is turned off. When the lever 31 is located at the position indicated by the broken line in FIG. 2, the light blocking portion 44 is located at a position where the light blocking portion blocks the light beam emitted from the light emitting portion of the sensor 32, and thus the sensor 32 is turned on. When the sensor 32 is in the ON state, the medium 2 is passing.

As illustrated in FIGS. 2 and 3, in the embodiment, the elongated sliding surface 37 is inclined in the longitudinal direction with respect to the wide surfaces 38. The inclination is achieved by increasing the amount of projection of the sliding surface 37 from the wide surfaces 38 on a side closer to the shaft portion 39 and decreasing the amount of projection on a side farther from the shaft portion 39.

The partially enlarged view of FIG. 2 illustrates a state slightly before the end portion 36 of the medium 2 in the transport direction F contacts the sliding surface 37, slides along the sliding surface 37, and passes through a distal end part 43 of the sliding surface 37. That is, the view shows a state slightly before the end portion contact portion 34 completely pivots. This partially enlarged view is shown in a perspective view for easy understanding of the structure, and the medium 2 is shown by a broken line, which is located anterior to the sliding surface 37 and the wide surfaces 38.

Since the sliding surface 37 is elongated, when the end portion 36 of the medium 2 contacts the sliding surface 37 and the lever 31 starts to pivot, the portion of the end portion 36 of the medium 2 in contact with the sliding surface 37 slides and advances in the transport direction F while maintaining the contact state with the sliding surface 37. As the medium 2 advances in the transport direction F, the contact position with the sliding surface 37 gradually and continuously moves from the end portion 36 to the surface side. That is, a surface portion 47 as the contact portion with the sliding surface 37 changes to be in contact with the sliding surface 37.

Accordingly, the medium 2 starts to bend in a concave shape with the position of the surface portion 47 as the contact portion with the sliding surface 37 as a base point. That is, in the medium 2, other surface portions 48 in the width directions (Y directions) coupled to the surface portion 47 in contact with the sliding surface 37 of the leading end surface portion of the medium 2 in the transport direction F starts to approach the wide surfaces 38. When the medium 2 has low rigidity, not only the surface portion 47 is in contact with the sliding surface 37, but also the other surface portions 48 are in contact with the wide surfaces 38.

The position of the medium 2 in the partially enlarged view of FIG. 2, that is, the position where the medium 2 contacts the sliding surface 37 is a position where the amount of projection of the sliding surface 37 from the wide surfaces 38 is smaller by the inclined structure. At this position, the other surface portions 48 of the medium 2 easily come into contact with the wide surfaces 38.

Further, in the embodiment, as described above, in the state in which the end portion contact portion 34 completely pivots, the distal end parts 42 of the wide surface portion 35, that is, the distal end parts 42 of the wide surfaces 38 come into contact with the surface 49 of the medium 2. Furthermore, the distal end part 43 of the end portion contact portion 34, that is, the distal end part 43 of the sliding surface 37 also comes into contact with the surface 49 of the medium 2.

That is, in the embodiment, in the state in which the end portion contact portion 34 completely pivots, both the distal end parts 42 of the wide surface portion 35 and the distal end part 43 of the end portion contact portion 34 come into contact with the surface 49 of the medium 2. In other words, the amount of projection of the distal end part 43 of the end portion contact portion 34 from the wide surfaces 38 is substantially zero.

In the embodiment, the width dimension W2 of the wide surfaces 38 is set to a dimension larger than 8.5 mm. The dimension is set based on the size of the hole of the loose leaf, which is typically 8.5 mm. Here, the width dimension W2 of the wide surfaces 38 is 8.5 mm.

The width dimension W2 of the wide surfaces 38 may be set to be smaller than 8.5 mm in consideration of the fact that the position of the hole of the loose leaf to be transported does not often coincide with the position of the wide surfaces 38 in the transport direction F, variations in the position of the hole, and the like. For example, the dimension may be set to half, that is, 4.25 mm.

In the embodiment, the end portion contact portion 34 is disposed at the center part in the width directions (Y-axis directions) intersecting the transport direction F of the transport path 8 in which the medium 2 is transported.

### Modification of Embodiment 1

In a modification of Embodiment 1, the lever 31 is configured to be movable, i.e., pivotable in the forward direction and the reverse direction of the transport direction F. This is achieved by using two torsion coil springs in opposite directions of spring force. That is, the configuration is achieved by setting the position of the lever 31 indicated by the solid line in FIG. 2 to a position where the spring forces of the two torsion coil springs are balanced. In this case, the restricting portion 46 and the restricted portion 45 are not provided.

Here, the forward direction is a direction away from the medium mounting portion 6 in the transport path 8, and the reverse direction is a direction toward the medium mounting portion 6.

Further, the end portion contact portion 34 and the wide surface portion 35 are respectively provided on both of the surface facing in the forward direction and the surface facing in the reverse direction.

### Explanation of Functions of Embodiment 1

The end portion 36 of the transported medium 2 in the transport direction F comes into contact with the sliding surface 37 of the end portion contact portion 34 having the narrow width projecting from the wide surfaces 38 in advance. Since the sliding surface 37 is elongated, when the end portion 36 of the medium 2 contacts the sliding surface 37 and the lever 31 starts to pivot, the portion of the end portion 36 of the medium 2 in contact with the sliding surface 37 slides and advances in the transport direction F while maintaining the contact state with the sliding surface 37. As the medium 2 advances in the transport direction F, the contact position with the sliding surface 37 gradually and continuously moves from the end portion 36 to the surface side. Accordingly, as illustrated in the partially enlarged view of FIG. 2, the medium 2 starts to bend in a concave shape with the contact portion with the sliding surface 37 as a base point. That is, in the medium 2, the other surface portions 48 in the width directions coupled to the surface portion 47 in contact with the sliding surface 37 of the leading end surface portion of the medium 2 in the transport direction F starts to approach the wide surfaces 38.

The degree of approach of the surface portions 48 of the medium 2 approaching the wide surfaces 38 to the wide surfaces 38 varies depending on the rigidity of the medium 2. The medium 2 having high rigidity is often transported in a state where the surface portion 47 is in contact with only the sliding surface 37 and the surface portions 48 are not in contact with the wide surfaces 38. On the other hand, the medium 2 having low rigidity is often transported in a state where the surface portion 47 is in contact with the sliding surface 37 and the surface portions 48 are also in contact with the wide surfaces 38.

That is, in the medium 2 having low rigidity, the reaction force of the lever 31 is received by both the surface portion 47 of the medium 2 in contact with the sliding surface 37 and the surface portions 48 in contact with the wide surfaces 38.

### Explanation of Effects of Embodiment 1

(1-1) In the embodiment, the lever 31 includes the end portion contact portion 34 having the elongated sliding surface 37 with which the end portion 36 in the transport direction F of the medium 2 transported along the transport path 8 comes into contact and slides, and the wide surface portion 35 provided on the end portion contact portion 34 and having the wide surfaces 38 with the width dimension W2 larger than the width dimension W1 of the end portion contact portion 34 in the width directions (Y-axis directions) intersecting the transport direction F. Further, the lever 31 projects from the wide surfaces 38 such that the sliding surface 37 comes into contact with the end portion 36 of the transported medium 2 in advance.

According to the configuration, as described above, in the medium 2 having low rigidity, the reaction force of the lever 31 is received by both the surface portion 47 of the medium 2 in contact with the sliding surface 37 and the surface portions 48 in contact with the wide surfaces 38. Accordingly, the concentration of the reaction force received from the lever 31 on the sliding surface 37 having the narrow width as in the related art can be suppressed, and thus the possibility that the end portion 36 of the medium 2 and the surface portions 47 and 48 coupled to the end portion 36 are deformed by the reaction force can be reduced.

Further, the width of the sliding surface 37 with which the end portion 36 of the medium 2 comes into contact can be narrowed, and the lever 31 can accurately detect the position or the like of the transported medium 2.

(1-2) When the medium 2 is formed with holes like a loose leaf, as described above, the contact position of the medium 2 with the sliding surface 37 gradually and continuously moves from the end portion 36 to the surface side as the medium advances in the transport direction F. In this regard, in a case where the position of the end portion contact portion 34 and the hole are located in a line in the transport direction F, when the leading end portion 36 of the medium 2 passes the contact position with the sliding surface 37, the distal end part of the end portion contact portion 34, that is, the distal end part 43 is likely to fall into the hole. However, in the configuration, the wide surface portion 35 can reduce the possibility of falling into the hole.

(2) In the embodiment, the lever 31 is pivotable with the shaft portion 39 as the pivot fulcrum 40 and the end portion contact portion 34 and the wide surface portion 35 as the free end 41. Further, the lever 31 is configured such that the distal end parts 42 of the wide surface portion 35 come into contact with the surface 49 of the medium 2 when the end portion contact portion 34 completely pivots in contact with the medium 2 being transported.

That is, when the end portion 36 of the medium 2 passes through the position of the sliding surface 37 and the lever 31 completely pivots, the distal end parts 42 of the wide surface portion 35 come into contact with the surface 49 of the medium 2, thereby stabilizing the subsequent transport state of the medium 2 as compared with a state where the medium is transported in contact with only the end portion contact portion 34.

(3) In the embodiment, the sliding surface 37 is inclined with respect to the wide surfaces 38, and the amount of projection of the sliding surface 37 from the wide surfaces 38 is larger at the side closer to the shaft portion 39 and smaller at the side farther from the shaft portion 39. Accordingly, the effect of the first configuration can be more effectively obtained as compared with a structure in which the sliding surface 37 is not inclined with respect to the wide surfaces 38.

(4) In the embodiment, the width dimension W2 of the wide surfaces 38 is larger than 8.5 mm. As a result, the possibility of falling into the hole of the normal loose leaf can be reduced.

(5) Further, in the modification of the embodiment, the lever 31 is movable in the forward direction and the reverse direction of the transport direction F, and the end portion contact portion 34 and the wide surface portion 35 are respectively provided on both of the surface facing in the forward direction and the surface facing in the reverse direction. Accordingly, even when the medium 2 is transported in the forward direction or in the reverse direction with respect to the end portion contact portion 34, the effect described in (1) can be obtained for the transport in both directions.

(6) Further, in the embodiment, the end portion contact portion 34 is configured to be disposed at the center part in the width directions (Y-axis directions) intersecting the transport direction F of the transport path 8 along which the medium 2 is transported. That is, since the substantially center part in the width dimension of the medium 2 comes into contact with the end portion contact portion 34, the detection accuracy of the presence or absence of the medium 2 can be improved.

### Embodiment 2

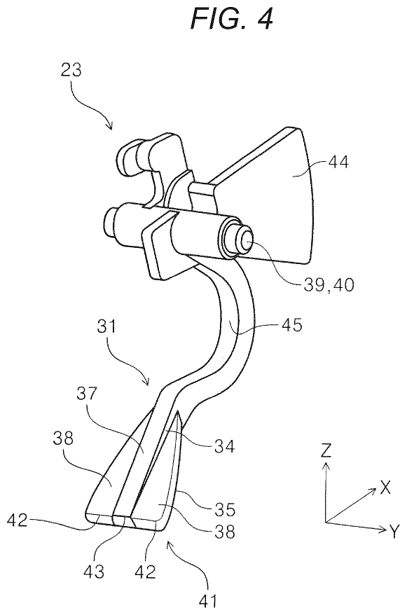

Next, a medium detection device 23 according to Embodiment 2 will be described with reference to FIG. 4. The same portions as those of Embodiment 1 have the same signs, and the description of the configurations and the corresponding effects thereof is omitted.

The medium detection device 23 of Embodiment 2 is different from that of the Embodiment 1 in the shape of the wide surface portion 35. Specifically, the wide surface portion 35 is configured to be gradually smaller in the width dimension from the distal end parts 42 toward proximal end parts. In other words, the wide surfaces 38 of the wide surface portion 35 are configured to have substantially triangular shapes in a plan view.

In the embodiment, the width dimension of the wide surface portion 35 is configured to be gradually smaller from the distal end parts 42 toward the proximal end parts. Accordingly, an increase in weight due to the provision of the wide surface portion 35 can be suppressed as compared with a case of substantially quadrangular shapes.

### Embodiment 3

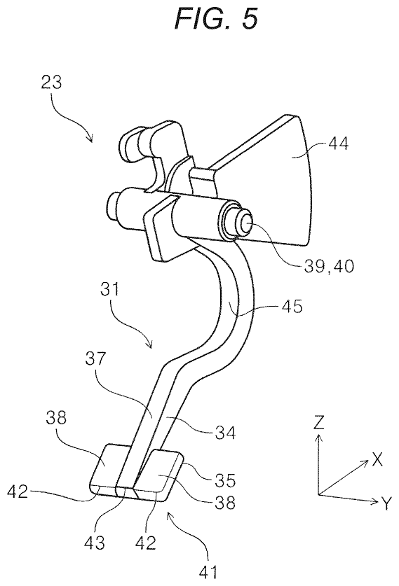

Next, a medium detection device 23 according to Embodiment 3 will be described with reference to FIG. 5. The same portions as those of Embodiment 1 have the same signs, and the description of the configurations and the corresponding effects thereof is omitted.

In the medium detection device 23 of Embodiment 3, the wide surface portion 35 is configured to be present in a range from a position where the transported medium 2 first comes into contact over the distal end parts 42 in the region where the end portion contact portion 34 extends. That is, on the sliding surface 37 of the end portion contact portion 34, a portion corresponding to a part opposite to the distal end parts 42 of the wide surface portion 35 is a position with which the medium 2 first comes into contact.

Here, “the position where the medium first comes into contact” at the position where the transported medium 2 first comes into contact in the region where the end portion contact portion 34 extends is not required to be a position that is strictly determined as one point in this specification, but is used in a sense of a position having a certain range in consideration of displacement of the leading end position of the transported medium 2 or the like.

In the embodiment, the wide surface portion 35 is configured to be present in the range from the position where the transported medium 2 first comes into contact over the distal end parts 42 in the region where the end portion contact portion 34 extends. Accordingly, an increase in weight due to provision of the wide surface portion 35 can be suppressed.

Method of Determining Amount of Projection of Sliding Surface from Wide Surfaces

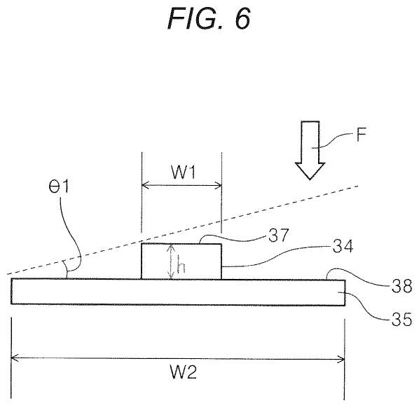

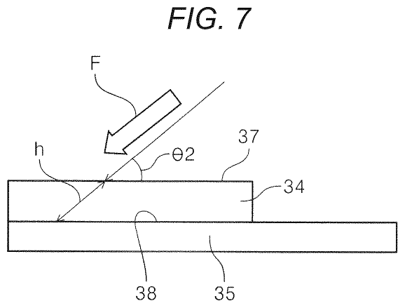

Next, a method of determining an amount of projection h of the sliding surface 37 of the end portion contact portion 34 from the wide surfaces 38 will be described with reference to FIGS. 6 and 7.

FIG. 6 illustrates a case where a sheet as the medium 2 perpendicularly approaches the sliding surface 37 of the end portion contact portion 34. In FIG. 6, an angle θ1 is an allowable sheet rotation angle. The allowable sheet rotation angle θ1 is a maximum allowable inclination angle when the sheet transported in the transport path 8 is transported with an inclination. The amount of projection h is determined such that the leading end of the sheet comes into contact with the sliding surface 37 ahead of the wide surfaces 38 even when the sheet is transported with an inclination at the angle θ1.

The amount of projection h is obtained by h=[(W2−W1)/2]×tan θ1.

FIG. 7 illustrates a case where the medium 2 approaches the sliding surface 37 of the end portion contact portion 34 at an entry angle θ2, not perpendicularly. When the medium approaches the sliding surface 37 at the entry angle θ2, not perpendicularly, the amount of projection h obtained in FIG. 6 is a distance in the direction shown in FIG. 7. Accordingly, even when the thickness of the end portion contact portion 34 is reduced, the necessary amount of projection h can be secured. That is, the thickness of the end portion contact portion 34 can be reduced by approaching the sliding surface 37 at the entry angle θ2.

### Other Embodiments

The medium detection device 23 according to the present disclosure and the image reading apparatus 1 including the medium detection device 23 basically have the configurations of the above described embodiments, however, obviously, the configurations can be partially changed, omitted, etc., without departing from the gist of the present disclosure.

In the above described embodiments, the case where the image reading apparatus 1 is used as the electronic apparatus is described, however, obviously, the present disclosure is not limited to the image reading apparatus and can be applied to an image forming apparatus such as a printer, and the like.

In the above described embodiments, the movement of the lever 31 is described as pivot, however, the movement is not limited to pivot. The end portion contact portion 34 may be moved backward in a direction intersecting the sliding surface 37.

In addition, the wide surface portion 35 may be formed not by integral molding of the end portion contact portion 34 of the synthetic resin, but by being fixed to the end portion contact portion using a lightweight sheet material. Accordingly, an increase in weight of the lever 31 can be suppressed.

What is claimed is:

1. A medium detection device comprising:
a lever disposed in a transport path and being movable in contact with a medium transported in a transport direction along the transport path; and
a sensor detecting the medium based on movement of the lever, wherein
the lever includes
an end portion contact portion having an elongated sliding surface with which an end portion in the transport direction of the medium transported along the transport path comes into contact and slides, and
a wide surface portion provided in the end portion contact portion and having a wide surface with a width dimension larger than a width dimension of the end portion contact portion in a width direction intersecting the transport direction, and
the sliding surface projects from the wide surface to be antecedently in contact with the end portion of the transported medium.

2. The medium detection device according to claim 1, wherein
the lever is pivotable with a shaft portion as a pivot fulcrum and with the end portion contact portion and the wide surface portion as a free end, and
when the end portion contact portion completely pivots in contact with the medium being transported, a distal end part of the wide surface portion comes into contact with a surface of the medium.

3. The medium detection device according to claim 2, wherein
the sliding surface is inclined with respect to the wide surface, and
an amount of projection of the sliding surface from the wide surface is larger at a side closer to the shaft portion and smaller at a side farther from the shaft portion.

4. The medium detection device according to claim 1, wherein
the width dimension of the wide surface is larger than 8.5 mm.

5. The medium detection device according to claim 1, wherein
the lever is movable in a forward direction and a reverse direction of the transport direction, and
the end portion contact portion and the wide surface portion are respectively provided on both of a surface facing the forward direction and a surface facing the reverse direction.

6. The medium detection device according to claim 1, wherein
the end portion contact portion is disposed at a center part in the width direction intersecting the transport direction of the transport path along which the medium is transported.

7. The medium detection device according to claim 2, wherein
the width dimension of the wide surface portion is gradually smaller from the distal end part toward a proximal end part.

8. The medium detection device according to claim 2, wherein
the wide surface portion is present in a range from a position where the transported medium first comes into contact over the distal end part in a region where the end portion contact portion extends.

9. An electronic apparatus comprising:
the medium detection device according to claim 1;
a medium transport unit that transports the medium along the transport path; and
a processing unit that executes processing on the transported medium.
